(19) United States
(12) Patent Application Publication
(10) Pub. No.: US 2026/0154499 A1
(43) Pub. Date: Jun. 4, 2026

(54) DOCUMENT TABLE DETECTION

(71) Applicant: Astrata, Inc., Pittsburgh, PA (US)

(72) Inventors: Eugene Tseytlin, Pittsburgh, PA (US); Ryan Dickson, Pittsburgh, PA (US); Caleb Dusenbery, Pittsburgh, PA (US)

(21) Appl. No.: 19/285,293

(22) Filed: Jul. 30, 2025

Related U.S. Application Data
(60) Provisional application No. 63/678,430, filed on Aug. 1, 2024.

(51) Int. Cl. G06F 40/279; G06F 16/22; G06F 40/103; G06F 40/163; G06F 40/40

(52) U.S. Cl. CPC G06F 40/279; G06F 16/2282; G06F 40/103; G06F 40/163; G06F 40/40

(57) ABSTRACT

Methods, systems, and apparatus, including computer programs encoded on computer storage media, for table detection using text streams. One of the methods includes detecting, in a text stream and using column identification data, text for one or more cells in a table; creating, using the text for at least some of the one or more cells in the table, a data structure for the cell a) that associates two or more values from the table and b) for use by a downstream system as part of a natural language analysis process of data from the text stream; and storing, in memory, the data structure.

### CROSS-REFERENCE TO RELATED APPLICATION

This application claims the benefit of U.S. Provisional Application No. 63/678,430, filed on Aug. 1, 2024, the contents of which are incorporated by reference herein.

### BACKGROUND

Natural language processing (“NLP”) systems can process documents to detect relationships between words in a single document. For instance, an NLP system can process a document to determine contextual nuances of the language included in the document when such nuances are not explicitly included in the document or the document's metadata.

### SUMMARY

In general, one aspect of the subject matter described in this specification can be embodied in methods that include the actions of detecting, in a text stream and using column identification data, text for one or more cells in a table; creating, using the text for at least some of the one or more cells in the table, a data structure for the cell a) that associates two or more values from the table and b) for use by a downstream system as part of a natural language analysis process of data from the text stream; and storing, in memory, the data structure.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, creating the data structure includes: detecting, from the text stream, a label for the table; and creating, for the at least some of the one or more cells in the table, the data structure for the cell that identifies the label for the table and data for the cell.

In some implementations, creating the data structure includes: determining two or more labels for the table; for each of at least some of the one or more cells in the table: predicting a label, using the two or more labels, that corresponds to the cell; and creating the data structure for the cell that identifies the label and data for the cell.

In some implementations, predicting the label includes: predicting a column label for the cell; and predicting a row label for the cell; and creating the data structure includes creating the data structure for the cell that identifies the column label, the row label, and the data for the cell.

In some implementations, creating the data structure associates a modifier from a group including the label or the data with an anchor from the group.

In some implementations, the method includes detecting a title for the table, wherein the data for the cell includes the title for the table.

In some implementations, the method includes detecting, from a plurality of table types each of which have different column identification data, a type of a table in the text stream, wherein: detecting the text for the one or more cells in the table uses the column identification data for the type of the table.

In some implementations, the method includes providing the data structure to a downstream system for use during a natural language analysis process of the data from the text stream.

In some implementations, detecting the text for the one or more cells in the table includes detecting, in the text stream that does not include any table markers spaces or delineation markers, and using the column identification data, the text for the one or more cells in the table.

In some implementations, the column identification data includes one or more of a pipe character, a tab character, or one or more whitespace characters.

In some implementations, the column identification data includes the one or more whitespace characters; the one or more whitespace characters have a length that satisfies a length threshold; and detecting the text for the one or more cells in the table uses the length of the one or more whitespace characters.

In some implementations, detecting, in the text stream and using the column identification data, the text for one or more cells in a table includes: detecting one or more empty cells around the detected text for the one or more cells; and associating, using data for the empty cells, the column identification data with the text for the one or more cells in the table.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, detecting a table in a text stream can improve natural language processing results generated from the text stream. In some implementations, the processing of text streams, e.g., detecting of text for cells in a table, is faster than other table detection processes, e.g., optical or image processing-based solutions. In some implementations, generation of a data structure for at least a portion of a table detected in a text stream provided can reduce computational resource usage, e.g., fewer computational cycles to detect the table, fewer computational resources to save the table, or both, compared to other systems. For instance, detecting a table in a text stream need not require original source image data. In some implementations, by generating a data structure that has the same format for different cells in a table or different tables can improve the accuracy of data processing given a more uniform input data for downstream processing.

In some implementations, detecting tables through various text stream formats can improve computational efficiency by not requiring specialized input formats, e.g., formatting text within a text stream through the use of a delimiter such as a comma value separator or tab value separator. In some instance, efficiency is improved by detecting tables without reformatting various text streams. In some implementations, the detection of tables through text streams can improve memory efficiency by outputting data structures representing table cells with relevant data, e.g., avoiding outputting blank tables, using less memory to store data structures representing a table, or both. In some implementations, the processing of tables can extract useful information from the source document that a computer might not otherwise detect, e.g., skip blank tables or consolidate mostly blank tables into data structures.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment including a text conversion system that can process a text stream to produce one or more data structures for further processing.

FIG. 2 is a flow diagram of an example process for table detection using text streams.

FIG. 3 is a block diagram of a computing system that can be used in connection with computer-implemented methods described in this specification.

Like reference numbers and designations in the various drawings indicate like elements.

### DETAILED DESCRIPTION

Some natural language processing (“NLP”) systems can process text data that is represented as a plain text, e.g., American Standard Code for Information Interchange (“ASCII”) file. This can enable these NLP systems to more efficiently process data, e.g., compared to systems that analyze scanned documents, images, and other types of data. When original data comes in other formats such as an electronic document, PDF and Rich Text Format (“RTF”), a component of the NLP system, or another system, can down convert the original data into plain text to enable the NLP system to process the plain text.

However, a straight conversion process from original data that is not plain text into plain text might not maintain relationships for data in tables, forms, or other non-text components within the original data. For instance, some source data can use tables and check boxes to represent clinical notes, lists, property values, questionnaires, technical documents, or legal documents, to name a few examples. A table could include delineation such as lines, commas, symbols of characters, or a combination of these, to delineate the data into rows and columns. These delineations could exist in the original data or be added by the conversion to plain text. When a document is down converted into plain text and the down conversion includes tables or non-text related data, an NLP system processing the document could incorrectly analyze the content of the document by ignoring the space where the table is, misaligning the data in the columns and rows, or any other error that would lose or misrepresent the data.

As a result, an NLP system can use different strategies for processing text and determining whether portions of the text potentially represent tables of data converted from the original data. Some strategies include determining, through the processing of text, whether a table is fixed or delineated. The NLP system can detect potential rows and columns of a table using fixed spacing between portions of text, delineation, contextual data, modifiers, or other determined data. Using the potential rows and columns of a table, the system can create a data structure representing data from the table. The NLP system can detect data associated with the table such as modifiers, labels, titles, or other equivalent data. The NLP system can associate the data structure with the data associated with the table.

Although image processing and recognition, and other similar methods can perform the analysis of tables within documents, converting to plain text and processing the text to detect the existence of the tables can provide a faster process, a less resource demanding process, or both. The NLP system can process text to detect tables in a manner that improves speed and minimizes the resources used. This improvement can be in part due to the NLP capability to process the tables within documents with relevant information, e.g., avoids processing of empty or partially filled tables. For example, if a table were determined to not include relevant information or to be entirely blank, the system might not process the table, e.g., can determine to skip processing the table, to discard data for the table, or both.

Identifying and evaluating information within tables is something that a human can accomplish, or image processing can accomplish. However, the processes of determining relevant information within and among the blank spaces of a table is more difficult for a computer to perform and image processing generally consumes more computational resources.

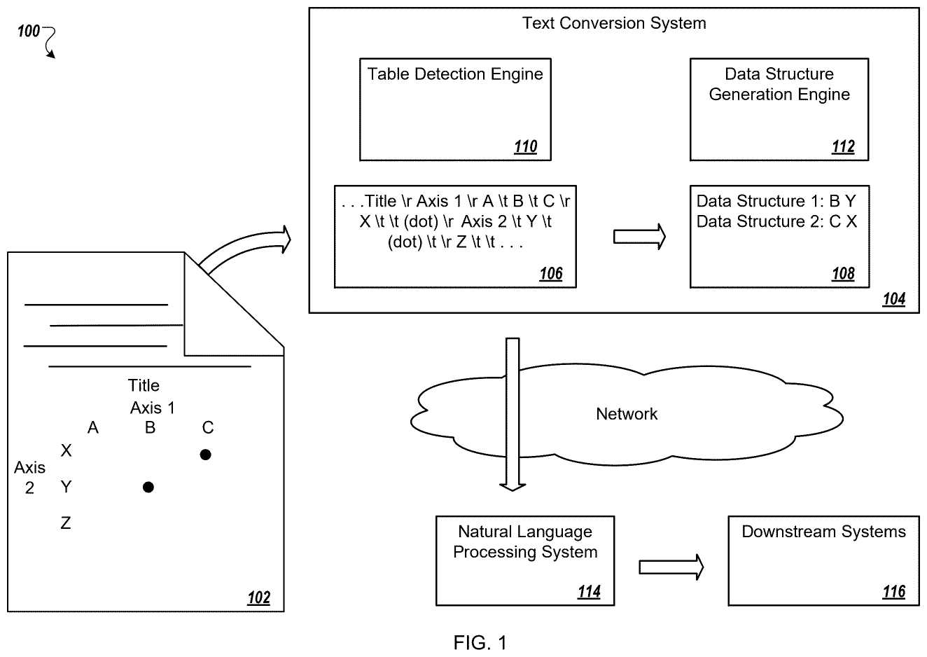

FIG. 1 is an example environment 100 including a text conversion system 104 that can process a text stream 106 to produce one or more data structures 108 for further processing. The text stream 106 can represent one or more documents, e.g., document 102, form which content was inserted into the text stream 106, e.g., when the body of the document 102 was used to generate the text stream 106. The document 102 can include one or more pages. The text conversion system 104 can receive one or more text streams 106 and, through processing using various software engines as described in more detail below, create data structures 108 that represent the data previously included in the table of a document.

A text stream 106 can represent a document as a continuous stream of text, e.g., without formatting normally included in a depiction of a document. The continuous stream may include portions of the document that are presented for human interpretation of the document, such as headers, footers, page numbers, or a combination thereof. However, since the data is included in a continuous stream, the headers and footers are not visually identifiable as they would be when presented in a user interface and are instead represented by various control characters, such as new line characters, e.g., “/r”.

For example, FIG. 1 shows document 102 with the originally formatted table. The text stream 106 shows the textual representation of the table as “ . . . Title \r Axis 1 \r A \t B \t C \r X \t \t (dot) \r Axis 2 \t Y \t (dot) \t \r Z \t \t. . . . ” This text stream example represents first “Title” as a title for the table from the original document 102. Following the “Title” is “\r” which is a carriage return for representing a new line. With a new line started, “Axis 1” is a label for the horizontal axis from document 102 is followed with another carriage return represented by “\r.” Next, “A,” “B,” and “C” are labels for respective columns under “Axis 1” and that are separated with spaces or tabs represented by “\t” for tab. The next carriage return “\r” establishes the first row with a label “X” followed by two “\t” or tabs that align the “(dot)” under the “C” column and in the “X” row. Following the “(dot)” is another carriage return “\r” followed by the “Axis 2” label for the horizontal axis, a tab, and the “Y” label for the second row. Within the second row “Y,” there is a tab, a “(dot)” and another tab. This aligns the “(dot)” of the “Y” row in the “B” column as seen in the table from document 102. After the next carriage return “\r”, the “Z” row is labeled followed by three tabs. This series of tabs represents the empty “Z” row.

As described in the above example text stream, although a human could more easily determine the meaning of data when depicted in a document, human comprehension of the data in the text stream is more difficult (disregarding that a human will not generally view the data in the text stream). In contrast, although a computer might have difficulty determining the meaning of data when depicted in a visual representation in the document, e.g., image data, a computer can more easily analyze the data in the text stream.

The conversion of a document into a text stream 106 can cause the loss of contextual information that was included in the document. For instance, the text stream 106 can include portions of the document that a computer can have difficulty associating with other portions of the text stream, e.g., a page number in the middle of a sentence captured between the bottom of a first page and the start of a second page or values to corresponding rows. Visual representations in the document can likewise be converted into a text stream such that the table's axes, title, labels, other appropriate data, or a combination thereof, are included in the text stream 106 without readily identifiable contextual information. In some instances, the table might only include empty cells and no useful information need be extracted from the table. In some instances, the table might contain only partial information.

The text conversion system 104 can reassociate the data within cells of the table with the appropriate column identification data, row identification data, title, or a combination of these. The reassociation of the cells of the table containing data with the appropriate column identification data, row identification data, title data, or a combination of these, e.g., referred to as label data, can enable the system to generate data structures representing the original cell data with associated label data. In some examples, a table has only a symbol within the cell data, e.g., a check mark, “X,” “dot” or other equivalent mark. In these examples, the cell data alone conveys only a marker for the intersection of a row and column. The text conversion system 104 can associate, in memory, a symbol from the cell data with appropriate contextual data from within the text stream 106. The contextual data can be label data that can indicate contextual information for the symbol within the cell data.

The text conversion system 104 receives a text stream that represents a document 102 from a source system. The source system can receive physical or digital documents, e.g., from a system that generates or otherwise maintains the document 102. The source system generates the text streams from the original documents using any appropriate process. For example, document 102 can be a PDF, rich text file, scanned image, or other appropriate document type. The source system can convert document 102 into a text stream 106 for further processing by the text conversion system 104. In some instances, the document 102 contains images, figures, graphs, tables, or a combination thereof. When the document 102 contains a mix of text and non-text components, the source system generates a text stream that represents the mix of text and non-text components. In some instances, the text conversion system 104 can provide a message to the source system confirming receipt of the text stream 106, after processing the text stream 106, or both.

The text conversion system 104 can use a table detection engine 110 to process at least portions of the text stream 106. For instance, the table detection engine 110 can detect cells of a table represented in the text stream by determining whether characters or patterns within the text stream 106 likely represent content for a table. The table detection engine 110 outputs data structures 108 that represent the cell data, contextual label data, or both.

The table detection engine 110 can use any appropriate type of data, pattern, or combination of both, to detect a potential table in the text stream 106. Several different types of tables that contain different table characteristics can exist in document 102. Table characteristics can include a number of columns, a number of rows, a width of a column, a width of a row, types of data in a table, e.g., in a cell or a header, other appropriate characteristics, or a combination of these. For example, medical history forms may contain cells in which a check box is marked, a temperature record can contain a single horizontal axis for time and temperature along the vertical axis. Tables can include different values for the cell data such as numbers, words, symbols, or a combination thereof. Tables can contain different values for each axis, e.g., temperature, dates, words, or a combination thereof. In some examples, tables might have only one entry, e.g., only one cell has data among several rows and columns. In some instances, a table can contain a single row and many columns. In some implementations, a table is a single row with two columns, e.g., a “yes” or “no” check box. In some examples, tables may not include titles or axis labels. In some examples, the tables are forms which are filled out with check boxes, bubbles, or “x's.” In some examples, a table can lack axis labels or other characteristics from a “typical” table. In some instances, tables are visually represented in different ways such as grid lines, delineation markers, white spaces, or a combination thereof. Each of these different types of tables presents unique challenges for the table detection engine 110 in detecting the cell data and associated label data.

The table detection engine 110 can detect a table using data for the corresponding types. For instance, the table detection engine 110 can detect a candidate table type for data in the text stream 106. This can include the table detection engine 110 detecting various table characteristics, patterns, or both, represented within the text stream for a corresponding table type. The table detection engine 110 can determine whether the characteristics, patterns, or both, satisfy corresponding type criteria for a table type. The table detection engine 110 can determine a number of characteristics of a candidate table present in a text stream. Upon determining that one or more table type criteria are satisfied, the table detection engine 110 can determine that a table is likely represented by a section of the text stream 106.

The table detection engine 110 can use any appropriate type of data for the table type criteria. In some instances, the table detection engine 110 can detect a table type using pattern recognition to determine patterns in the spacing or delineations in the table, e.g., such that the table type criteria represent one or more table patterns. In some instances, the engine can detect portions of the table using pattern recognition to determine patterns in the spacing or delineations in the table. In some examples the table detection engine 110 can detect a table type using contextual data in the text stream, e.g., such that different contextual data represents different table types for the table type criteria.

In some examples, the table detection engine 110 can repeatedly perform a threshold analysis to determine when a table ends. For instance, the table detection engine 110 can use the table type criteria for analysis of each row of text in the text stream 106. The table detection engine 110 can detect the end of a table when a detected table type changes, e.g., is different than a table type for a prior row, or when the table detection engine 110 determines that a current row likely does not have a table type, e.g., represents data that is not likely from a table.

In some instances, the table detection engine 110 can use a threshold analysis to determine whether two rows, tables, or a combination of both, adjacent to each other are separate tables or part of the same table. For instance, the table detection engine 110 can use the analysis threshold to detect, in a document 102 that originally shows two tables adjacent to each other or above and below each other for comparison, whether the two tables are likely part of a single table or separate tables. The analysis threshold can indicate that when two rows have different patterns, different table types, or a combination of both, that the two rows are likely part of separate tables. The analysis threshold can indicate that when a subsequent row likely has a predetermined label type, e.g., of a type that was not previously detected for the table, that the subsequent row is likely a separate table. This can occur when the text stream 106 includes two adjacent tables and the subsequent row has a title for the second table.

In some instances, the table detection engine can detect a table, or rows in a table, using delineation marker patterns. In some instances, the delineation markers indicate a format of the table. In some examples, a table can contain a grid or pipe (|) characters to delineate each column and row. For example, a text stream can include “A |B|C,” or “A|\t B|\t C|\r.” In some instances, space or whitespace characters can delineate values for individual cells. For instance, “A B C \r.” In some examples, tabs (\t) characters delineate different cells. For instance, “A \t B \t C \r.” Each of these example delineations can apply in a horizontal row or vertical row. In some examples, a new row is delineated with a new line, a carriage return (\r), or “line feed” (\n). In some instances, a new row is indicated by a row of underscore characters followed by a carriage return and another row of data. The table detection engine 110 can detect the delineation pattern per row, per column, within the table as a whole, or a combination thereof. Each cell, row, column, or a combination of these, can weigh separately or together in the analysis of whether a table likely exists in the text stream 106.

In some instances, the table detection engine 110 can detect new rows after a series of columns. In some examples, this can occur when the table detection engine 110 detects the repeated number of columns followed by a carriage return. In some instances, this can occur when the table detection engine 110 detects a symmetry of carriage returns and an axis label. For example, the last three carriage returns have begun with a tab (\t), then a carriage return is followed by a single word, then the three next carriage returns begin with a tab (\t). In this example, the single word could indicate the axis label spaced evenly among the several rows of the table.

In some instances, the table detection engine 110 can detect a table using patterns in the column labels, row labels, axis values, or a combination thereof. For example, an axis of time can have a set format for the numbers and a pattern in the incremental values, e.g., 1:00, 1:10, 1:20. In some examples, a pattern of spacing between values can indicate a potential axis label and candidate table, e.g., counting by 10's as in 10, 20, 30. In some instances, the repeating units through several columns or rows can indicate a candidate table, e.g., inches, degrees, or percentage. In some examples a legend of values and symbols can indicate a candidate table. In some examples, the units can proceed a carriage return (\r). The combination of the units and carriage return can indicate a pattern and a candidate table within the text stream 106. In some examples, the symmetry of the axis, cells, or other equivalent table characteristics can indicate a candidate table.

The table detection engine 110 can detect the end of a table using any appropriate operations, e.g., which can be similar to the operations described elsewhere in this specification. In some examples, the table detection engine 110 determines that a pattern of delineation markers for a current row likely no longer matches a pattern for the previous row and the previous carriage return was likely the last row of the table. In some examples, the pattern in delineation markers might represent a consistent change, likely indicating a new table. In some instances, the table detection engine 110 detects symmetry, e.g., a pattern in values, in the table and determines the table is likely ended. In some examples, the table detection engine 110 detects a horizontal axis label using the label determines the table is likely ended.

The table detection engine 110, using the table characteristics, can associate cell data with the appropriate column, row, or both, identification data. For example, in FIG. 1 the table detection engine can detect a “dot” within the text stream and, using the pattern of delineation markers, determine that the “dot” is in the “X” row and “C” column. In some instances, the association the cell data can include an association of two axis labels together. For example, the “dot” can indicate the intersection of “X” row and “C” column and the axis labels can indicate the units associated with “X” and “C,” e.g., “X degrees” and “C hours.” In some examples, the table detection engine 110 associates the table title with the cell data. In some examples, the table detection engine 110 can associate the cell data with non-text symbols, e.g., the data next to a check box with each cell data. This could occur when the input document 102 was originally a hard copy document in which a box is checked with data next to the box, e.g., a hand-written note next to the check box, a “yes” or “no” check box next to a question. In this example, the cell data structure, described in more detail below, might not require the column and row information, or even the title, when outputting the data structure.

In some implementations, the table detection engine 110, using the table characteristics, can determine to skip associating cell data with the appropriate column and row identification data. For example, some tables can contain blank cells, voided cells, empty check boxes, or other equivalent indication that the cell data is blank. In these instances, the table detection engine 110 can determine to skip associating the cell with appropriate column and row identification data.

The text conversion system 104 can include a data structure generation engine 112. The data structure generation engine 112 can receive association data, e.g., that identifies cell data and associated label data, from the table detection engine 110. Using the received association data, the data structure generation engine 112 can create data structures that include the cell data, column identification data, row identification data, axis label data, title data, other appropriate data, or a combination thereof. Using the received data, the data generation engine 112 can create data structure 108 as output.

The data structure 108 can have any appropriate structure, type, or both. For instance, the data structure 108 can have a structure that corresponds to a data schema maintained by the data structure generation engine 112. In some examples the data structure can have a cell data format, a cell data/column data format, a cell data/row data format, or a combination of these. The data structure generation engine 112 can select a format, from multiple formats, using a type of the table.

The cell data structure format can include the cell data in the data structure without column or row identifiers. For example, a table can purely organize data and not require column or row labels. Here the data structure would include the cell data in the data structure, e.g., in a data structure that includes a single field for the cell data, because no row or column labels or data exist in the original table.

The cell data/column data structure format can include the cell data and column data. In some instances, a table in the document 102 can include date and time columns in which each row contains a set of measures for the date and time of the column. In these instances, each column in the table can represent a day of the week. When generating the data structures for the cells under a column, the data structure can include the column label, e.g., the label of the day of the week, and the cell data of the one or more cells under the column. The data structure can include a first field for the column label and a second field for the cell data. In some examples a single data structure can represent the one or more cells under the column. In some examples multiple data structures can represent data from an individual cell under the column and each of the data structures can include the column label, e.g., the day of the week. In some examples the column labels act as attributes or anchors, described in more detail below, for the data structure.

The cell data/row data structure format can include the cell data and row data. In some examples, a table in the document 102 can include date and time rows in which each row contains a measure of time. In these examples, each row in the table can represent a time of day and each column a day of the week. When generating data structures for a row, the data structure can include the row label, e.g., the time of day, and the cell data of the one or more cells within the row. The data structure can include a first field for the row label and a second field for the cell data. In some examples a single data structure can represent the one or more cells within the row. In some examples multiple data structures can represent data from an individual cell within the row and each of the data structures can include the row label e.g., the time of day. In some examples the row labels act as attributes or anchors, described in more detail below, for the data structure.

An anchor can, for example, define an event. The event can be any appropriate type of event, such as text describing a network security event, a diagnosis, or an anatomical site.

The data structure can associate the anchor with a modifier. The modifier can be any appropriate phrase that is associated with the event. For instance, a temporal modifier can indicate a time instance, a time period, or a combination of both, during which the event likely occurred. When the temporal modifier is a particular date, e.g., Oct. 10, 2023, and an event is a network security event, e.g., indicating that a network security device was compromised, then the data structure can indicate that the network security device was compromised on that date.

The engine can determine relevant context data to include in each data structure 108. In some instances, the data structure generation engine 112 can determine to associate data for multiple cells from the same table together. The data structure generation engine 112 can group the data together for a single data structure output or provide separate data structures for each cell. In some instances, the data structure can include an individual cell's data with only the column and row identifiers. In some examples the data structure can include any relevant label data.

The output for the text conversion system can be a data structure 108. The data structure can represent the data from the cell of the table, can include relevant data associated with the cell, or both, e.g., from the axis values, table title, or a combination thereof. For example, the data structure can represent the axis values of the data in the table. In some instances, a table in which a “check mark,” “X,” “dot,” or equivalent non-text mark exists within the table cell, the data structure generation engine 112 can generate the data structure with the context of the labels of the “X” axis value and “Y” axis value. In some instances, the axis values can be labels. In some examples, the cell within the table contains text and the association of the axis values and table title provide contextual information relevant to the text within the cell. The data structure generation engine 112 can generate the data structure that represents the table in its entirety or portions of the table. In some instances, the data structure 108 can contain a portion of the data associated with the cell, e.g., the axis values but not the table title.

The text conversion system 104 can transmit the data structure 108 to various other systems, e.g., a natural language processing (“NLP”) system 114 or downstream systems 116, for processing. For example, a natural language processing system 114 can receive the data structure 108 and perform processing to detect the data within the structure for further presentation to a user. Since the data structure 108 can have the same format for different types of tables, different documents, different tables, or a combination of these, the NLP system 114 and the downstream systems 116 can more accurately process the data in the data structures, e.g., compared to systems that don't have a uniform format. The NLP system 114 can detect types of the data instruction in the data structure, e.g., as anchors or modifiers, which types can be used as part of the NLP process. In some examples, the data structure 108 can indicate the types of the data, e.g., as part of the data structure. In some examples, the downstream systems 116 can process the data structure 108 or data generated by the NLP system 114, e.g., to generate additional data, present at least some of the data on a display, perform another appropriate process, or a combination of these.

In some instances, the table detection engine 110 can detect a table using contextual data, label data, or both. For example, the table detection engine 110 can detect a title of a table, e.g., “Table 1,” “Temperature Table,” “Risk Table.” In some instances, the axis label can indicate a table e.g., “Temperature” separated by some characters then “Time.” In some instances, contextual phrases can indicate a table. For example, a table of medical history check boxes proceeded by the phrase “Check all that apply.”

In some instances, the table detection engine 110 can detect a table using the values within a cell. Some tables contain “dots,” “check marks,” “X's,” or any other equivalent symbol to indicate the intersection of the row and column within a table. For example, a human reader viewing the table in document 102 can detect that the “dot” aligns with “X” row and “C” column. The table detection engine 110 can detect this association of the “dot” with the “X” row and “C” column through the patterns of the delineation markers. In this example, the table detection engine 110 can use the “dot” itself to determine a table likely exists. Using the “dot,” the table detection engine 110 can search for other patterns within the table to associate the “dot” with the appropriate row and column data. For example, the table detection engine can detect a combination of characteristics such as text within cells.

In some instances, the environment 100 can include systems, engines, or both, that determine information contextually from surrounding text within the text stream, inferring relevant concepts from the text, determining modifiers of the text, or a combination of both. For instance, the text conversion system 104 can use the contextual information when determining a table type, include data processed from the surrounding text in the data structure 108, or a combination of both. In some examples, the NLP system 114 can determine context for data using the data structure 108. For instance, although the table might include the values of both B (as a column label) and Y (as a row label), the data structure 108 can indicate that these two values are contextually related. As a result, the NLP system 114 can more accurately analyze data for the document 102, e.g., from the text stream 106 or data structure 108, compared to other systems by using the data structure 108.

The text conversion system 104 is an example of a system implemented as computer programs on one or more computers in one or more locations, in which the systems, components, and techniques described in this specification are implemented. A network (not shown), such as a local area network (“LAN”), wide area network (“WAN”), the Internet, or a combination thereof, can connect the text conversion system 104, and the other components, e.g., source system, NLP system 114, other downstream systems 116, or any combination thereof. The text conversion system 104 can use a single computer or multiple computers operating in conjunction with one another, including, for example, a set of remote computers deployed as a cloud computing service.

The text conversion system 104 can include several different functional components, including a table detection engine 110, and a data structure generation engine 112. The table detection engine 110, data structure generation engine 112, or a combination of these, can include one or more data processing apparatuses, can be implemented in code, or a combination of both. For instance, each of the table detection engine 110 and data structure generation engine 112 can include one or more data processors and instructions that cause the one or more data processors to perform the operations discussed herein.

The various functional components of the text conversion system 104 can be installed on one or more computers as separate functional components or as different modules of a same functional component. For example, the components table detection engine 110 and data structure generation engine 112 of the text conversion system 104 can be implemented as computer programs installed on one or more computers in one or more locations that are coupled to each through a network. In cloud-based systems for example, these components can be implemented by individual computing nodes of a distributed computing system.

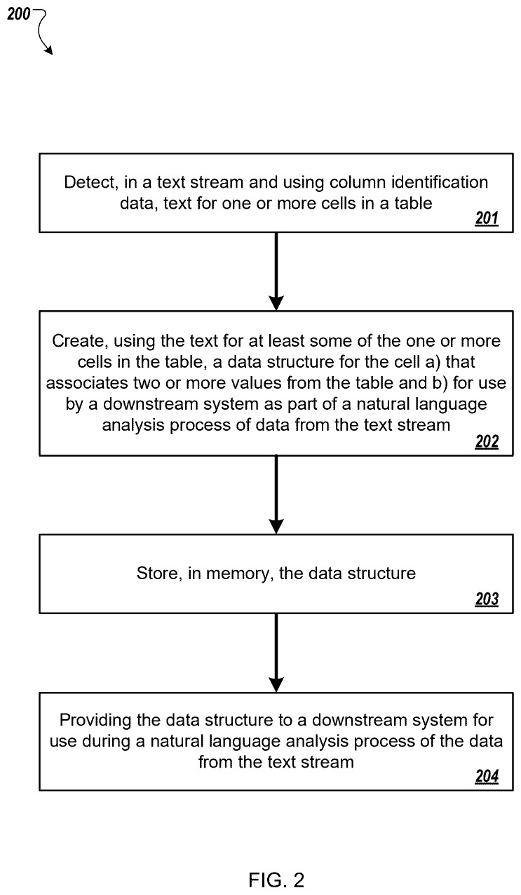

FIG. 2 is a flow diagram of an example process 200 for table detection using text streams. For example, the process 200 can be used by the text conversion system 104 from the environment 100. Thus, descriptions of process 200 may reference one or more of the above-mentioned components, or computational devices of the text conversion system 104.

The process 200 includes detecting, in a text stream and using column identification data, text for one or more cells in a table (201). For example, the text conversion system can use a table detection engine to detect tables within a text stream. Some examples of column identification data can include patterns, contextual data, or both. The table detection engine can detect one or more tables that can include one or more cells.

The table detection engine can detect tables, portions of tables, or surrounding contextual data related to tables. In some examples, the table detection engine detects patterns in the text stream that represent a candidate table. In some instances, the patterns can include delineation; symmetry within the data; white spaces; contextual data, e.g., titles, axis labels, and/or legends; or a combination of these. For example, the table detection engine can detect several repeating “check boxes” followed by text and detect the data as a candidate table. In these cases, the table can represent a list of questions with check boxes to indicate a “yes” or “no” answer to the question followed by an explanation. In some examples, the table detection engine detects contextual data that indicates a candidate table. For instance, the table detection system can detect in the text stream, units, labels, titles, legends, or a combination thereof. For example, the detection within a text stream of the words “table” can indicate the presence of a candidate table. In some examples, the detection of a legend of units, labels, symbols or a combination thereof can indicate a candidate table.

The process 200 includes creating, using the text for at least some of the one or more cells in the table, a data structure for the cell (202). The data structure for the cell can a) associate two or more values from the table and b) be for use by a downstream system as part of a natural language analysis process of data from the text stream. For example, the text conversion system 104 can use a data generation engine to generate data structure representing the data from the cells of the table, surrounding contextual data, or both. The data structure generation engine can associate the candidate table cell with appropriate column or row identification data. In these examples, the data structure generation engine can associate a non-text mark at the intersection of a row and column with the row and column labels. In some instances, a table may have values within a cell and the units of the value in a column label. In these instances, the data structure generation engine can associate the value from the cell with the units in the column identification data, e.g., column label.

The process 200 includes storing, in memory, the data structure (203). For example, the text conversion system 104 can store the data structure for later processing or transmitting to downstream systems. In some instances, the data structures are stored in groups of data associated with the same tables, with the same text streams, with related text streams or a combination thereof. For example, the text conversion system can group cells from a single table into a collection of data structures, or combine the data for multiple cells in a table into a single data structure. In some examples, the text conversion system can group data structures from a single text stream as related. In some examples, various text streams can relate to each other and the text conversion system can group data structures from the various text streams together.

The data structure generation engine can provide the data structures for use by a downstream system. For example, the data structure can associate the table cell data with the axis labels, title, legend, or a combination thereof. In this example, the downstream systems can process the data structure without the text stream data unrelated to the cell data, e.g., tabs (\t), pipes (|), blank cells, or any other non-related data. By providing the data structure that associates data that was not associated in the text stream and that does not include the unrelated data, the data structure generation engine can enable more accurate processing of data for the text stream by the downstream systems.

The process 200 includes providing the data structure to a downstream system for use during a natural language analysis process of the data from the text stream (204). For example, the text conversion system 104 can provide data structures to NLP systems for further processing for presentation to a user. In some examples, the text conversion system can provide the data structures to a software program for presentation to a user.

In some implementations, the process 200 can include additional operations, fewer operations, or some of the operations can be divided into multiple operations. For example, the process 200 might not include operation 204. In some examples, the table detection engine can run iteratively to detect different tables using different criteria, e.g., patterns, text recognition, symmetry recognition, or a combination of these. In some instances, the data structure generation engine can output multiple data structures for different data associations for a single cell, a whole table, or a combination thereof. For instance when a single cell has two different data associations, the data structure generation engine can output two data structures, one for each association.

In this specification, the term “database” is used broadly to refer to any collection of data: the data does not need to be structured in any particular way, or structured at all, and it can be stored on storage devices in one or more locations. A database can be implemented on any appropriate type of memory.

An electronic document, which for brevity will simply be referred to as a document, may, but need not, correspond to a file. A document may be stored in a portion of a file that holds other documents, in a single file dedicated to the document in question, or in multiple coordinated files.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

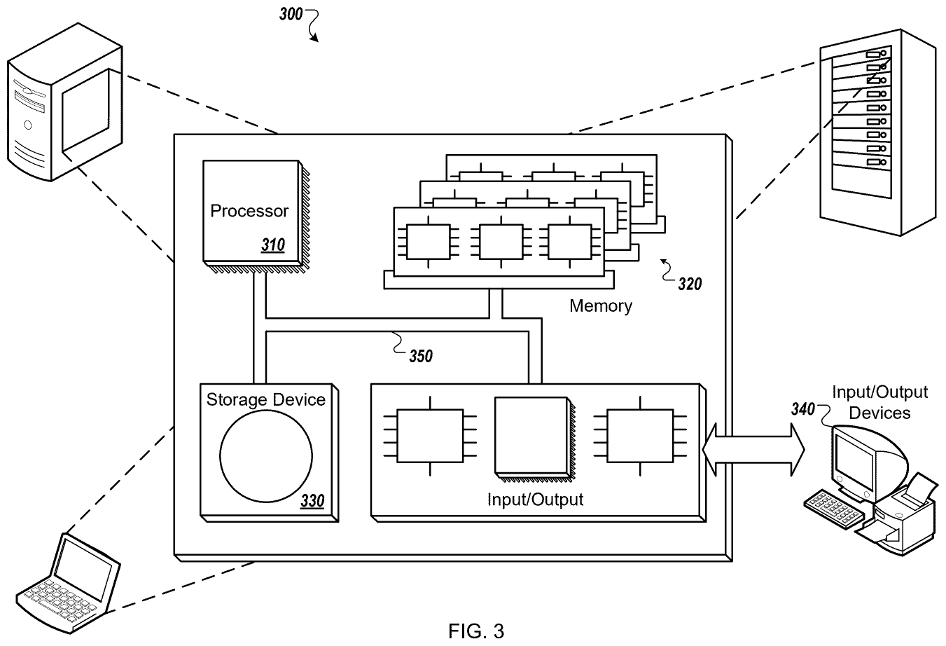

An example of one such type of computer is shown in FIG. 3, which shows a schematic diagram of a computer system 300. The computer system 300 can be used for the operations described in association with any of the computer-implemented methods described previously, according to some implementations. The computer system 300 includes a processor 310, a memory 320, a storage device 330, and an input/output device 340. Each of the components 310, 320, 330, and 340 are interconnected using a system bus 350. The processor 310 is capable of processing instructions for execution within the computer system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the computer system 300. In some implementations, the memory 320 is a computer-readable medium. In some implementations, the memory 320 is a volatile memory unit. In some implementations, the memory 320 is a non-volatile memory unit.

The storage device 330 is capable of providing mass storage for the computer system 300. In some implementations, the storage device 330 is a computer-readable medium. In some implementations, the storage device 330 can be a floppy disk device, a hard disk device, an optical disk device, or a tape device.

The input/output device 340 provides input/output operations for the computer system 300. In some implementations, the input/output device 340 includes a keyboard, a pointing device, a touchscreen, or a combination of these. In some implementations, the input/output device 340 includes a display unit for displaying graphical user interfaces. In some implementations, the input/output device 340 includes a microphone, a speaker, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
detecting, in a text stream and using column identification data, text for one or more cells in a table;
creating, using the text for at least some of the one or more cells in the table, a data structure for the cell a) that associates two or more values from the table and b) for use by a downstream system as part of a natural language analysis process of data from the text stream; and
storing, in memory, the data structure.

2. The method of claim 1, wherein creating the data structure comprises:
detecting, from the text stream, a label for the table; and
creating, for the at least some of the one or more cells in the table, the data structure for the cell that identifies the label for the table and data for the cell.

3. The method of claim 1, wherein creating the data structure comprises:
determining two or more labels for the table;
for each of at least some of the one or more cells in the table:
predicting a label, using the two or more labels, that corresponds to the cell; and
creating the data structure for the cell that identifies the label and data for the cell.

4. The method of claim 3, wherein:
predicting the label comprises:
predicting a column label for the cell; and
predicting a row label for the cell; and
creating the data structure comprises creating the data structure for the cell that identifies the column label, the row label, and the data for the cell.

5. The method of claim 3, wherein creating the data structure associates a modifier from a group comprising the label or the data with an anchor from the group.

6. The method of claim 3, comprising detecting a title for the table, wherein the data for the cell comprises the title for the table.

7. The method of claim 1, comprising:
detecting, from a plurality of table types each of which have different column identification data, a type of a table in the text stream, wherein:
detecting the text for the one or more cells in the table uses the column identification data for the type of the table.

8. The method of claim 1, comprising providing the data structure to a downstream system for use during a natural language analysis process of the data from the text stream.

9. The method of claim 1, wherein detecting the text for the one or more cells in the table comprises detecting, in the text stream that does not include any table markers spaces or delineation markers, and using the column identification data, the text for the one or more cells in the table.

10. The method of claim 1, wherein the column identification data comprises one or more of a pipe character, a tab character, or one or more whitespace characters.

11. The method of claim 10, wherein:
the column identification data comprises the one or more whitespace characters;
the one or more whitespace characters have a length that satisfies a length threshold; and
detecting the text for the one or more cells in the table uses the length of the one or more whitespace characters.

12. The method of claim 1 wherein, detecting, in the text stream and using the column identification data, the text for one or more cells in a table comprises:
detecting one or more empty cells around the detected text for the one or more cells; and
associating, using data for the empty cells, the column identification data with the text for the one or more cells in the table.

13. A system comprising one or more computers and one or more storage devices on which are stored instructions that are operable, when executed by the one or more computers, to cause the one or more computers to perform operations comprising:
detecting, in a text stream and using column identification data, text for one or more cells in a table;
creating, using the text for at least some of the one or more cells in the table, a data structure for the cell a) that associates two or more values from the table and b) for use by a downstream system as part of a natural language analysis process of data from the text stream; and
storing, in memory, the data structure.

14. The system of claim 13, wherein creating the data structure comprises:
detecting, from the text stream, a label for the table; and
creating, for the at least some of the one or more cells in the table, the data structure for the cell that identifies the label for the table and data for the cell.

15. The system of claim 13, wherein creating the data structure comprises:
determining two or more labels for the table;
for each of at least some of the one or more cells in the table:
predicting a label, using the two or more labels, that corresponds to the cell; and
creating the data structure for the cell that identifies the label and data for the cell.

16. The system of claim 15, wherein:
predicting the label comprises:
predicting a column label for the cell; and
predicting a row label for the cell; and
creating the data structure comprises creating the data structure for the cell that identifies the column label, the row label, and the data for the cell.

17. The system of claim 15, wherein creating the data structure associates a modifier from a group comprising the label or the data with an anchor from the group.

18. The system of claim 15, the operations comprising detecting a title for the table, wherein the data for the cell comprises the title for the table.

19. The system of claim 13, the operations comprising:
detecting, from a plurality of table types each of which have different column identification data, a type of a table in the text stream, wherein:
detecting the text for the one or more cells in the table uses the column identification data for the type of the table.

20. One or more computer storage media encoded with instructions that, when executed by one or more computers, cause the one or more computers to perform operations comprising:
detecting, in a text stream and using column identification data, text for one or more cells in a table;
creating, using the text for at least some of the one or more cells in the table, a data structure for the cell a) that associates two or more values from the table and b) for use by a downstream system as part of a natural language analysis process of data from the text stream; and
storing, in memory, the data structure.
